(19) United States
(12) Patent Application Publication
(10) Pub. No.: US 2005/0094653 A1
(43) Pub. Date: May 5, 2005

(54) Permanent virtual channel/path connection modify

(75) Inventors: Barton J. Milburn, Baden, PA (US); Balajee Nagasubramaniam, Cranberry Township, PA (US); Lingaraj Patil, Wexford, PA (US)

Correspondence Address: Ansel M. Schwartz;Suite 304, 201 N. Craig Street, Pittsburgh, PA, 15213, US

(73) Assignee: Marconi Communications, Inc.

(21) Appl. No.: 10/700,206

(22) Filed: Nov. 3, 2003

(51) Int. Cl. H04L 12/56

(52) U.S. Cl. 370/409; 370/395.2

(57) ABSTRACT

A switch for a telecommunications network includes at least one fabric for switching PVx connections. The switch includes at least one input mechanism for receiving PVx connections from the network. The switch includes a plurality of output mechanisms for sending PVx connections to the network, with at least one of the output mechanisms non-modifiable. The switch includes a controller which modifies parameters for the connections of the fabric, the input mechanism, and the non-modifiable output mechanism by destroying them and then recreating the PVx connections of the non-modifiable output mechanism while the input mechanism, output mechanism, fabric and connections are active and operating. A switch for a telecommunications network includes at least one fabric for switching SVx connections. A method for handling connections in a telecommunications network.

### FIELD OF THE INVENTION

The present invention is related to modifying parameters for connections to a switch with at least one non-modifiable output mechanism. More specifically, the present invention is related to modifying parameters for connections to a switch with at least one non-modifiable output mechanism by destroying the connections and then recreating the connections of the non-modifiable output mechanism while the switch is active and operating.

### BACKGROUND OF THE INVENTION

ATM service providers provide ATM PVC/PVP (PVX) connections to end users. Each of these PVxs has a specific QOS associated with it. If the end user desires a different QOS for his PVx, the PVx must be destroyed and re-created in order to apply the new QOS.

The present invention allows the QOS to be dynamically modified without disturbing the ATM PVx. ATM SPs can now offer a higher level of service due to less down-time. The QOS can be modified without disturbing the user's traffic.

### SUMMARY OF THE INVENTION

The present invention pertains to a switch for a telecommunications network. The switch comprises at least one fabric for switching PVx connections. The switch comprises at least one input mechanism for receiving PVx connections from the network. The switch comprises a plurality of output mechanisms for sending PVx connections to the network, with at least one of the output mechanisms non-modifiable. The switch comprises a controller which modifies parameters for the connections of the fabric, the input mechanism, and the non-modifiable output mechanism by destroying them and then recreating the PVx connections of the non-modifiable output mechanism while the input mechanism, output mechanism, fabric and connections are active and operating.

The present invention pertains to a method for handling connections in a telecommunications network. The method comprises the steps of sending a modify signal for modifying parameters regarding connections in the network to a switch having at least one fabric for switching PVx connections, at least one input mechanism for receiving PVx connections from the network, and a plurality of output mechanisms for sending PVx connections to the network, with at least one of the output mechanisms non-modifiable. There is the step of destroying the connections of the non-modifiable output mechanism. There is the step of recreating the connections of the non-modifiable output mechanism subject to the modify parameters.

The present invention pertains to a switch for a telecommunications network. The switch comprises at least one fabric for switching SVx connections. The switch comprises at least one input mechanism for receiving SVx connections from the network. The switch comprises a plurality of output mechanisms for sending SVx connections to the network, with at least one of the output mechanisms non-modifiable. The switch comprises a controller which modifies parameters for the connections of the fabric, the input mechanism, and the non-modifiable output mechanism by destroying them and then recreating the PVx connections of the non-modifiable output mechanism while the input mechanism, output mechanism, fabric and connections are active and operating.

The present invention pertains to a method for handling connections in a telecommunications network. The method comprises the steps of sending a modify signal for modifying parameters regarding connections in the network to a switch having at least one fabric for switching SVx connections, at least one input mechanism for receiving SVx connections from the network, and a plurality of output mechanisms for sending SVx connections to the network, with at least one of the output mechanisms non-modifiable. There is the step of destroying the connections of the non-modifiable output mechanism. There is the step of recreating the connections of the non-modifiable output mechanism subject to the modify parameters.

### BRIEF DESCRIPTION OF THE DRAWINGS

In the accompanying drawings, the preferred embodiment of the invention and preferred methods of practicing the invention are illustrated in which:

FIG. 1 is a block diagram of a switch of the present invention.

FIG. 2 is a schematic representation of the switch.

### DETAILED DESCRIPTION

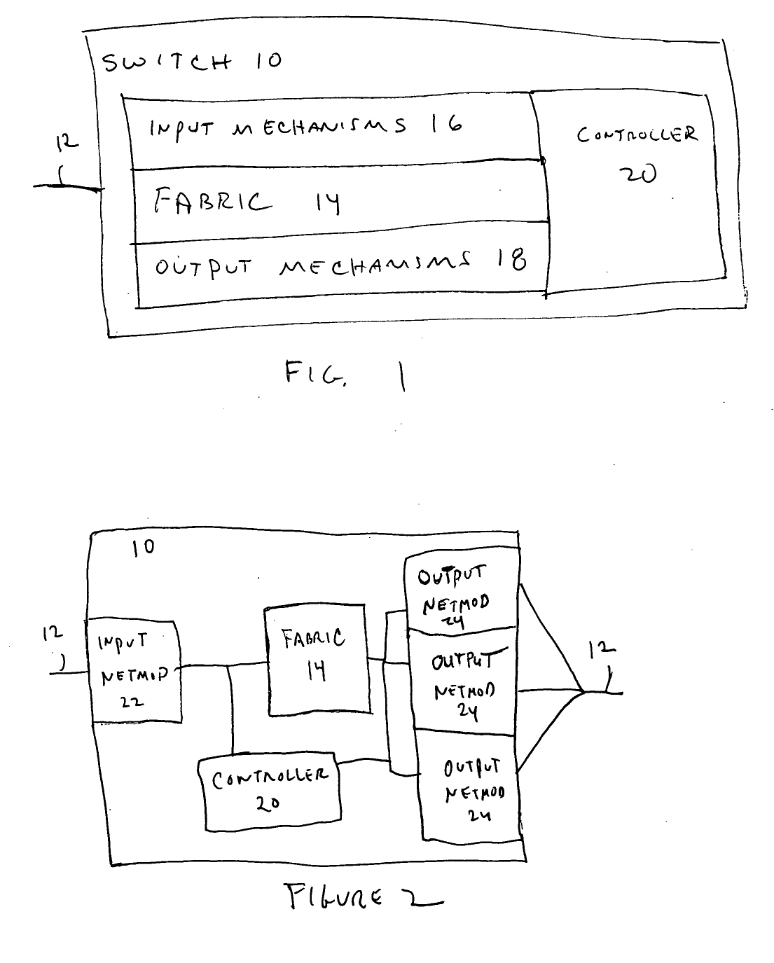

Referring now to the drawings wherein like reference numerals refer to similar or identical parts throughout the several views, and more specifically to FIG. 1 thereof, there is shown a switch 10 for a telecommunications network 12. The switch 10 comprises at least one fabric 14 for switching PVx connections. The switch 10 comprises at least one input mechanism 16 for receiving PVx connections from the network 12. The switch 10 comprises a plurality of output mechanisms 18 for sending PVx connections to the network 12, with at least one of the output mechanisms 18 non-modifiable. The switch 10 comprises a controller 20 which modifies parameters for the connections of the fabric 14, the input mechanism 16, and the non-modifiable output mechanism 18 by destroying them and then recreating the PVx connections of the non-modifiable output mechanism 18 while the input mechanism 16, output mechanism 18, fabric 14 and connections are active and operating.

Preferably, cells of a connection of the non-modifiable output mechanism 18 that is modified are discarded after the connection is destroyed and until the connection is recreated. The input mechanism 16 preferably is an input netmod 22. Preferably, the output mechanism 18 is an output netmod 24.

The present invention pertains to a method for handling connections in a telecommunications network 12. The method comprises the steps of sending a modify signal for modifying parameters regarding connections in the network 12 to a switch 10 having at least one fabric 14 for switching PVx connections, at least one input mechanism 16 for receiving PVx connections from the network 12, and a plurality of output mechanisms 18 for sending PVx connections to the network 12, with at least one of the output mechanisms 18 non-modifiable. There is the step of destroying the connections of the non-modifiable output mechanism 18. There is the step of recreating the connections of the non-modifiable output mechanism 18 subject to the modify parameters.

Preferably, the recreating step includes the step of recreating the connections within 50 milliseconds. There is preferably the step of the discarding cells of the connections of the non-modifiable output mechanism 18 after they have been destroyed and until they are recreated.

In the operation of the invention, and referring to FIG. 2, packets of connections on a network 12 are received at an input netmod 22 of a switch 10 and transferred to a fabric 14 of the switch 10, as is well known in the art. The fabric 14 sends the packets of the connections to a desired output netmod 24 which then sends the packets of the connections to the network 12 toward an ultimate destination, as is well known in the art.

At some point in time, it is desired to modify the parameters for the connections that the switch 10 receives, and a modified signal is received by the switch 10. The modify signal causes the input netmod 22, the fabric 14 and any output netmod 24 which are modifiable to be modified in regard to the new parameters for the connections. However, for the output netmod 24 of the switch 10 that is non-modifiable, a simple modification regarding the parameters of the connections that pass through it cannot occur, simply because it is not modifiable.

For each and every non-modifiable netmod in the switch 10, within 50 milliseconds or faster, the connections passing through the non modifiable netmod are destroyed, and then subsequently recreated, but when they are recreated, the connections of the non-modifiable netmod are recreated subject to the modified parameters. Any packets that are received by the switch 10 after its connection has been destroyed, but before the connection is recreated subject to the new parameters, are either discarded or tagged to be resent so that the packets are not lost during the short time period between when the connection is destroyed and is recreated. The recreation of the connection uses standard techniques that are well known in the art. The modification of the switch 10, including the input netmods 22, fabrics 14 and output netmods 24, whether modifiable or non-modifiable, occur while they are active and operating continuously transmitting cells so that the switch 10 does not have to be stopped or is lost from the network 12 for any time because the parameters for the connections are being modified.

It should be noted the above description can also be used for SVx connections, as the same can be used to modify SVx connections.

The following distinction is made regarding permanent virtual channel connections, and soft permanent channel connections. Permanent virtual channel connections are connections created through an ATM network 12. The ATM switches and the corresponding virtual channels through the switches are fixed. The intermediate switches and corresponding VPI and VCI values are fixed during the creation of the permanent virtual channel connection, and the paths and the VPI and VCI are previously determined before they are actually formed.

On the contrary, a soft permanent connection is created by just specifying the source switch, source port, source VPI/VCI, NSAP address of destination switch. It is the responsibility of the source switch to automatically setup the soft permanent channel connection dynamically using signaling procedures and an optimal routing path from the source switch to the destination switch. This is far superior to permanent virtual channel connection in the sense that management is much simpler, if there is a failure in the intermediate node, there are mechanisms to reroute the connection within the network 12. Thus, much more can be done with soft permanent connections than with permanent virtual connections.

In addition, the following distinction is made regarding permanent virtual paths, and soft permanent paths. Permanent virtual path connections are connections created through an ATM network 12. The ATM switches and the corresponding virtual paths through the switches are fixed. The intermediate switches and corresponding VPI value is fixed during the creation of the permanent virtual path connection, and the paths and the VPI are previously determined before they are actually formed.

On the contrary, a soft permanent path connection is created by just specifying the source switch, source port, source VPI, NSAP address of the destination switch. It is the responsibility of the source switch to automatically setup the soft permanent path connection dynamically using signaling procedures and an optimal routing path from the source switch to the destination switch. This is far superior to permanent virtual path connection in the sense that management is much simpler, if there is a failure in the intermediate node, there are mechanisms to reroute the connection within the network 12. Thus, much more can be done with soft permanent path connections than with permanent virtual path connections.

A Switched-Permanent Virtual Circuit (SPVC) is a PVC that is established manually across a UNI and dynamically across a Network-to-Network Interface (NNI). The SPVC stays up through the ATM network 12 in spite of many failures. If there is an ATM switch failure, the SPVC will be rerouted over the ATM network 12.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A switch for a telecommunications network comprising:
at least one fabric for switching PVx connections;
at least one input mechanism for receiving PVx connections from the network;
a plurality of output mechanisms for sending PVx connections to the network, with at least one of the output mechanisms non-modifiable; and
a controller which modifies parameters for the connections of the fabric, the input mechanism, and the non-modifiable output mechanism by destroying them and then recreating the PVx connections of the non-modifiable output mechanism while the input mechanism, output mechanism, fabric and connections are active and operating.

2. A switch as described in claim 1 wherein cells of a connection of the non-modifiable output mechanism that is modified are discarded after the connection is destroyed and until the connection is recreated.

3. A switch as described in claim 2 wherein the input mechanism is an input netmod.

4. A switch as described in claim 3 wherein the output mechanism is an output netmod.

5. A method for handling connections in a telecommunications network comprising the steps of:
sending a modify signal for modifying parameters regarding connections in the network to a switch having at least one fabric for switching PVx connections, at least one input mechanism for receiving PVx connections from the network, and a plurality of output mechanisms for sending PVx connections to the network, with at least one of the output mechanisms non-modifiable;
destroying the connections of the non-modifiable output mechanism; and
recreating the connections of the non-modifiable output mechanism subject to the modify parameters.

6. A method as described in claim 5 wherein the recreating step includes the step of recreating the connections within 50 milliseconds.

7. A method as described in claim 6 including the step of the discarding cells of the connections of the non-modifiable output mechanism after they have been destroyed and until they are recreated.

8. A switch for a telecommunications network comprising:
at least one fabric for switching SVx connections;
at least one input mechanism for receiving SVx connections from the network;
a plurality of output mechanisms for sending SVx connections to the network, with at least one of the output mechanisms non-modifiable; and
a controller which modifies parameters for the connections of the fabric, the input mechanism, and the non-modifiable output mechanism by destroying them and then recreating the SVx connections of the non-modifiable output mechanism while the input mechanism, output mechanism, fabric and connections are active and operating.

9. A method for handling connections in a telecommunications network comprising the steps of:
sending a modify signal for modifying parameters regarding connections in the network to a switch having at least one fabric for switching SVx connections, at least one input mechanism for receiving SVx connections from the network, and a plurality of output mechanisms for sending SVx connections to the network, with at least one of the output mechanisms non-modifiable;
destroying the connections of the non-modifiable output mechanism; and
recreating the connections of the non-modifiable output mechanism subject to the modify parameters.
